(19) United States
(12) Patent Application Publication
(10) Pub. No.: US 2026/0342670 A1
(43) Pub. Date: Oct. 29, 2026

(54) AI-DRIVEN RESOURCE HOTSPOT DETECTION AND AUTOMATED SUPPORT FOR ENTERPRISE ENVIRONMENTS

(71) Applicant: Dell Products L.P., Round Rock, TX (US)

(72) Inventors: Avinash Kumar, Bihar (IN); Gururaj Kulkarni, Bangalore (IN); Shelesh Chopra, Bangalore (IN)

(21) Appl. No.: 19/193,941

(22) Filed: Apr. 29, 2025

(51) Int. Cl. H04L 41/147; H04L 41/5009; H04L 41/5074; H04L 43/0817; H04L 43/0888

(52) U.S. Cl. CPC H04L 41/147; H04L 41/5009; H04L 41/5074; H04L 43/0817; H04L 43/0888

(57) ABSTRACT

An AI-driven resource hotspot detection method identifying bottlenecks for application execution in a distributed network. A telemetry data collector receives real-time telemetry data from resources and applications of the distributed network, and extracts resource utilization features. An AI-driven telemetry analysis component detects trends in resource usage from the resource utilization features, and performs pattern analysis of the detected trends to predict future resource bottlenecks as predictions. A natural language summary and actionable recommendations for bottleneck minimization are generated based on the predictions, and provided to the user. A service request support ticket can be automatically generated.

### TECHNICAL FIELD

Embodiments are directed to enterprise networks, and an AI-driven proactive resource hotspot detection and automated support system.

### BACKGROUND

Enterprise-level networks are often build on a distributed (or cluster) file system in which data is spread across multiple storage devices as may be provided in a cluster of nodes. Each computer forms a node in the system and runs its own instance of an operating system. The file system is shared by being simultaneously mounted on multiple servers, and presents a global namespace to the nodes so that files appear to be in the same central location. Distributed file systems are typically very large and may contain many hundreds of thousands or even many millions of files, as well as services (applications) that use and produce data. The Santorini file system provided by Dell Technologies, Inc. represents a type of cluster network system that stores the file system metadata on a distributed key value store and the file data on object store. The metadata can be accessed by any front-end node, and any file can be opened for read/write by any front-end node.

Resource hotspots in enterprise environments have a significant threat to system performance, reliability, and business continuity. These issues, such as running out of storage capacity, memory bottlenecks during peak backup windows, or overlapping policy schedules, often go unnoticed until they escalate into critical problems. Identifying such bottlenecks typically involves labor-intensive manual investigations by administrators and the developers, requiring deep expertise and time, which many customers lack. While telemetry data provides detailed information about system behavior, the absence of proactive analysis and prediction leaves customers unprepared to address these issues in a timely manner.

Furthermore, the growing complexity of enterprise systems, combined with dynamic workloads, worsens the challenge of identifying resource constraints early. From customer escalation reports, it has been seen that high-impact scenarios such as delayed replication, excessive deletion job queues, or schedule overlaps often result in system overloads, impacting operational efficiency. Customers need a more proactive approach to identify these potential risks and take action before they affect their systems.

For example, a customer's system might have millions of expired backup files queued for deletion, but the copy deletion jobs are not catching up. Over time, this backlog can grow significantly, consuming valuable storage resources and impacting the system's performance. For example, telemetry data may indicate that 100K backup copies remain undeleted, but without real-time analysis and proactive action, this issue persists. This can lead to a critical scenario where storage capacity runs out, disrupting ongoing backup and replication processes, and ultimately leaving the system vulnerable to operational failures.

What is needed, therefore, is a telemetry data processing system that proactively identifies, summarizes and notifies users about resource hotspots in their systems, and helps automate the resolution process.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell, Data Domain, and Santorini are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing an AI-driven proactive resource hotspot and automated resolution process for cluster networks, under some embodiments.

FIG. 2 illustrates a high-level overview of a network cluster using the Santorini architecture, under some embodiments.

FIG. 3 illustrates details of the services related to the data path running in Santorini cluster network, under some embodiments.

FIG. 4 is a block diagram of a resource hotspot detection and analysis system, under some embodiments.

FIG. 5 illustrates a proactive notification interface output for an example system, under some embodiments.

FIG. 6 is a flowchart that illustrates an overall method of providing resource hotspot detection and automated support, under some embodiments.

FIG. 7 is a block diagram of a computer system used to execute one or more software components for the distributed system of FIG. 1, under some embodiments.

### DETAILED DESCRIPTION

A detailed description of one or more embodiments is provided below along with accompanying figures that illustrate the principles of the described embodiments. While aspects of the invention are described in conjunction with such embodiments, it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

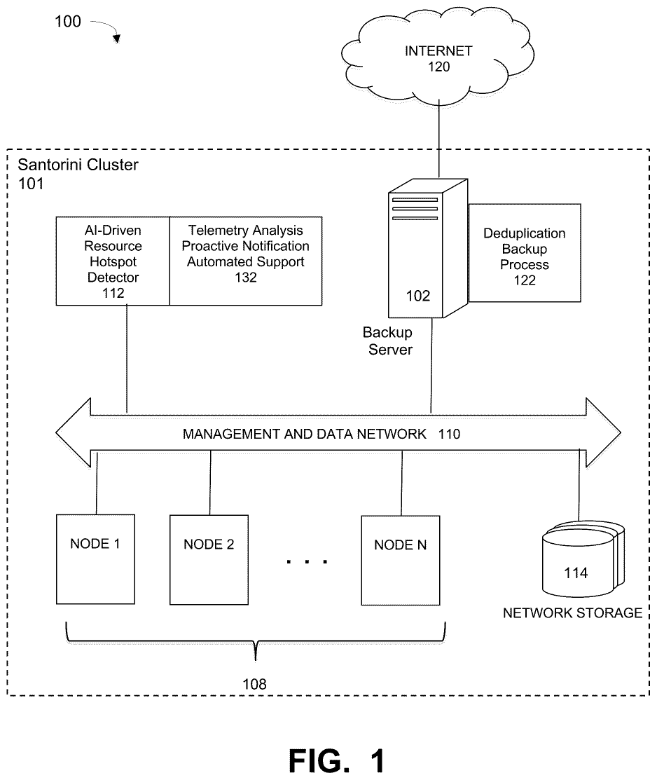

FIG. 1 is a block diagram of illustrating a distributed system implementing an AI-driven proactive resource hotspot and automated resolution process for cluster networks, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster system, cluster file system, or cluster network) typically consists of various processing components that run in different computer systems (nodes) that are connected to each other. These components communicate with each other over the network via messages and based on the message content, perform certain acts like reading data from the disk into memory, writing data stored in memory to the disk, perform some computation (CPU), sending another network message to the same or a different set of components and so on. These acts or ‘component actions,’ when executed in time order in a distributed system constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case network 101 supports various related file system and data managers, such as PowerProtect Data Manager (PPDM), as well as services such as ObjectScale object storage and other services.

In an embodiment, network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Although embodiments are described in the context of Data Domain file system (DDFS) and a Santorini cluster system, embodiments are not so limited and any architecture that requires a distributed logging service within given, configurable resources may be used.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment, cluster network 101 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

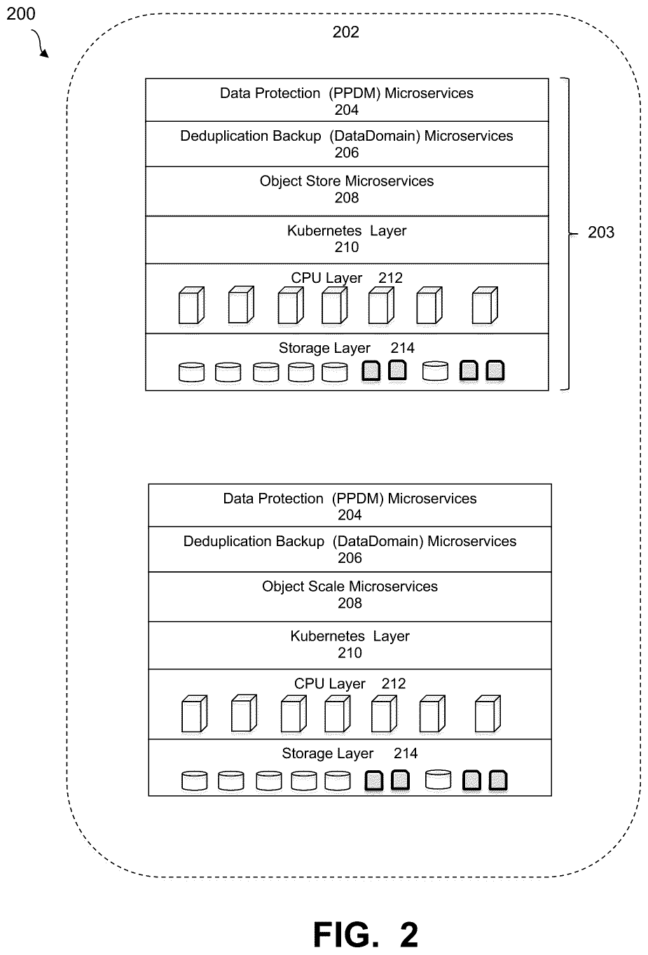

FIG. 2 illustrates a high-level overview of a network cluster using the Santorini architecture, under some embodiments. In system 200 of FIG. 2, a two-node cluster 202 is shown. Each node 203 consists of several distinct components or processing layers. For the example shown, a node includes a PowerProtect Data Manager (PPDM), or similar microservices layer 203, a Data Domain (deduplication backup) appliance microservices layer 206, an object storage (e.g., Dell ObjectScale) microservices layer 208, a Kubernetes layer 210, a processor layer 212, and a storage layer 214 including different types of storage media, such as HDD, Flash memory, SSD memory, and so on. Each of these component products consists of multiple microservices, and as more nodes are added, Santorini scales CPU, storage, RAM, and networking accordingly. Other layers can also be included, and a cluster 202 may comprise any practical number of nodes 203. The PPDM represents a cloud-native data protection manager system, and ObjectScale represents a scalable object storage manager.

As shown in FIG. 2, embodiments of the cluster network 200 through DD microservices 206 utilize Data Domain backup appliances to provide streaming deduplication, and which use the Data Domain File System (DDFS) as an inline data deduplication file system. As data gets written to the file system, DDFS creates variable sized segments and writes the unique segments to a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

As generally understood, “metadata” refers to system data or information that comprises descriptive information about data, such as file types, sizes, access patterns, and change rates, used to categorize and index files for efficient retrieval.

In a deduplicated file system that forms segments from data, these segments are uniquely identified by their key/label called a ‘fingerprint.’ Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

With respect to the directory tree structure of the data processed in system 100, various different data structures can be supported by the file system (e.g., DDFS or Santorini file system). A B+ Tree is self-balancing tree structure and is a variant of a standard B Tree, and Each file inode is stored in the B+ Tree as a data blob using the parent directory inode number and the child file inode number as the key. A B+ Tree key structure composed of the parent directory inode as the primary key and child file inode as the secondary key to construct the full key. An Mtree is a tree data structure similar to a B+ Tree (or R-tree), which is constructed using a metric and relies on triangle inequality for efficient range and k-nearest neighbor queries. As with other tree-based data structures, the Mtree is composed of nodes and leaves. In each node there is a data object that identifies it uniquely and a pointer to a sub-tree where its children reside. Every leaf has several data objects

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+ Tree. The L0 and Lp segments are written to separate containers, known as L0 and Lp containers.

A Data Domain or similar system can efficiently copy an existing file using the same underlying Merkle tree. It creates the new file with a new name, and therefore a new L₆ root of the tree, but that tree then references the identical L_{P} chunks. As this operation involves only the root of the tree, it is trivially fast and does not increase physical space in use beyond the one chunk containing the L₆.

In an embodiment, the PPDM (PowerProtect Data Manager) microservices layer 204 builds on the Data Domain system 206 to provide data protection capabilities for VM image backups and Kubernetes workloads.

Upon creation of an Mtree, it can identify the domain on which the Mtree is created. All namespace metadata as well as the file data and metadata associated with a Mtree is allocated from resources owned by that domain. The Mtree names as well as Mtree IDs are unique across the cluster. Santorini exposes a global namespace that is a union of all namespaces in all domains.

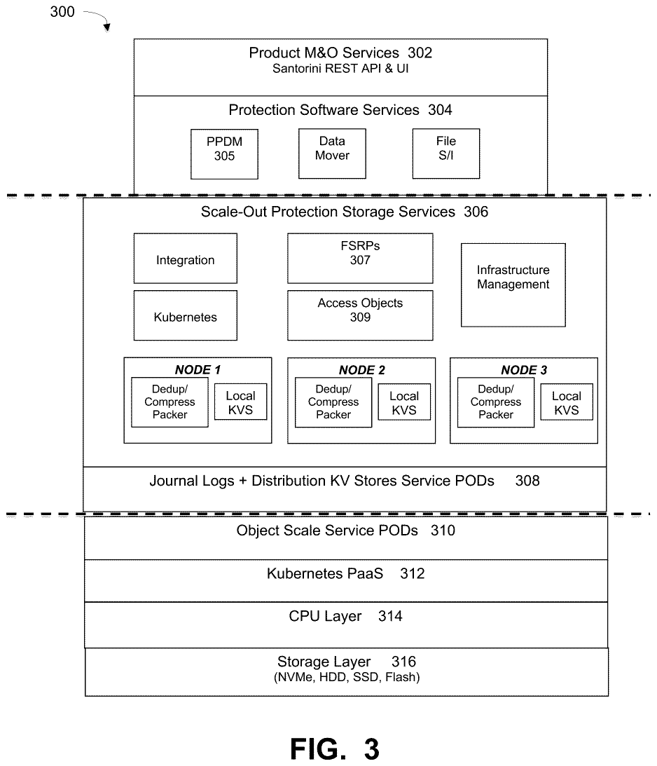

FIG. 3 illustrates details of the services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks. Also included in layer 306 are any number of nodes (e.g., Nodes 1 to 3, as shown), each containing a dedup/compression packer and a key-value (KV) store.

As an L1 is formed, a similarity group (simgroup) is calculated for the L1 based on the SHA1 fingerprints of the L0 segments (or other properties). The similarity group is checked against a mapping table, which leads to consistently routing the L1 based on its similarity group to an instance of a node's dedup/compress service. If similarity groups are in a range of 0-1023, then if there are four instances of the dedup/compress service, then the instances may uniquely be responsible for the ranges 0-255, 256-511, 512-767, 768-1023, though other mappings are possible. The dedup/compress instance will deduplicate the L0 segments relative to other fingerprints within the same similarity group. Other functionality exists in the dedup/compress service such as packing segments into compression regions, containers, and blobs that will be written to an underlying object storage such as provided by the object scale service layer 310, or an object store provided by the public cloud. Other layers of system 300 include a Kubernetes PaaS (platform as software) 312, a CPU layer 314, and a storage layer 316.

Distributed key value stores in 308 are also a component of Santorini and are used to hold much of the metadata such as the namespace Btree, the Lp tree, fingerprint index, and container fingerprints. These run as containers within the Santorini cluster and are stored to low latency media such as NVMe 316. There is also a distributed and durable log that replaces NVRAM for Santorini.

In summary, Santorini is an integrated scale out software solution developed by Dell Technologies that can run on-premises or in a public cloud. In an embodiment, the Santorini stack consists of PPDM as backup software, Data Domain scale out file system, and Object Scale as a storage pool, and these are run as services inside the Kubernetes container infrastructure. The Santorini scale-out file system consists of stateless independent Data Domain services which are responsible for data path. The state of Santorini file system is maintained in three components wherein data is put in object scale, metadata is stored in a distributed key value store (KVS), and logs are stored in a distributed log. The metadata and data can be logged at different rates by the various layers and components of system 300, thus adding complexity to the task of providing a synchronized point for crash recovery using these logs.

### Resource Hotspot Detection and Resolution

A distributed system provides many different resources for users as provided by the application nodes. Resource include programs, applications, services, as well as access to hardware systems, such as memory, storage, processors, interfaces, and so on. In large distributed systems with multiple nodes and users, overuse of certain resources may lead to “resource hotspots” that represent bottlenecks in processing capability. Keeping track of resource usage usually entails generating telemetry data, which comprises continuous system performance and resource utilization metrics. Such data can also be used to detect and predict resource hotspots.

Resource hotspots may represent bottlenecks in certain processing threads that execute deduplication backup programs in distributed networks, such as system 300 in FIG. 3. The protection software services 304 may all make extensive use of system resources, such as processors (CPU), local memory, offsite storage, interfaces, processing threads, container orchestration, and so on. Bottlenecks can readily arise when multiple nodes and/or applications compete for the same resources at the same time and require prioritization to ensure fair processing of queued events.

In present systems, identifying and addressing resource hotspots in customer environments often involves extensive manual effort. While telemetry data can highlight potential issues such as storage depletion or delayed copy replication, the lack of proactive processing means these issues go unnoticed until they escalate. Current solutions primarily are dependent on reactive methods, where customers are responsible for identifying potential resource issues within their environments. This typically involves manually filtering through telemetry data, interpreting trends, and diagnosing problems, which is both time-consuming and prone to human error. In many cases, customers only become aware of issues when system performance begins to degrade or critical failures occur.

Additionally, the process of creating support tickets remains manual, requiring customers to reach out to support teams, describe the issue, and upload logs. This leads to delays in response times and increases the burden on both customers and support teams. As a result, operational inefficiencies persist, and resource hotspots remain unaddressed until they escalate into critical failures. Finally, current solutions do not integrate Quality of Service (QoS)-based insights to drive automated remediation and resource optimization.

Embodiments of system 100 include an AI-driven resource hotspot detector component that utilizes telemetry data to proactively identify, summarize, and notify customers about resource hotspots while automating the resolution process. The component maps these insights to QoS-based actions and provide recommendations at the product/solution level while integrating with sales engines for infrastructure recommendations and licensing requests.

For purposes of description, the terms “customer” and “user” are generally used interchangeably to mean a user of the system, while a customer may imply a user that has paid or subscribed to a vendor of the system or application for access to system resources.

This solution integrates an AI-driven system to proactively detect, summarize, and resolve resource hotspots by leveraging QoS-based insights, automated resource mapping, and recommendation engines. In an embodiment, a telemetry analysis module 132 analyzes telemetry data in real-time, predicting trends such as memory pressure, storage capacity issues, and policy overlaps, and continuous monitoring is used to form the foundation for proactive issue detection and forecasting.

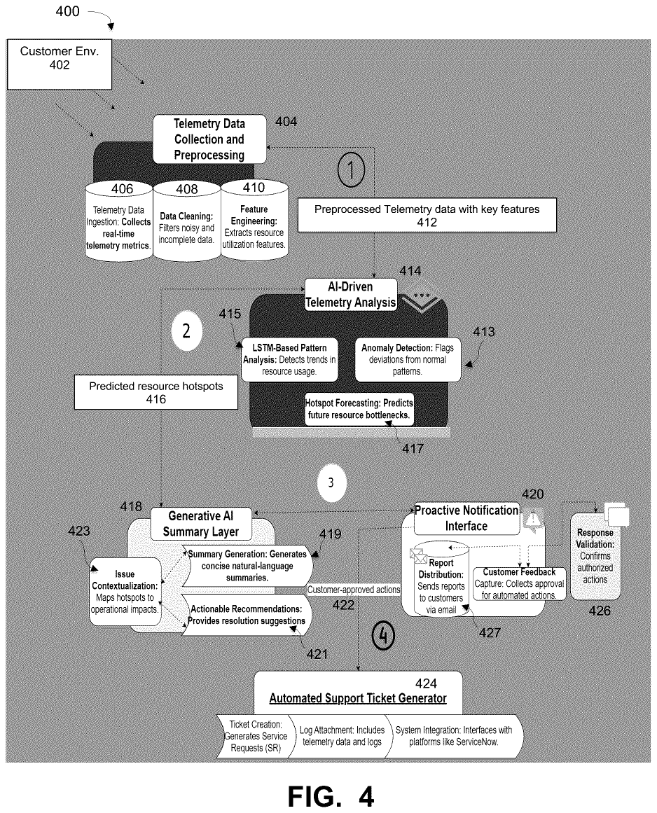

FIG. 4 is a block diagram of a resource hotspot detection and analysis system, under some embodiments. As shown in system 400 of FIG. 4, telemetry data from a user site or customer environment 402, which itself may comprise a large-scale distributed network, is input as data streams to a telemetry data collection and preprocessing component 404. This component includes a telemetry data ingestion stage 406, which collects the real-time telemetry metrics in the data sent from the user site. A data cleaning unit 408 filters and conditions noisy and incomplete data to provide full, clean data to a feature engineering component 410 that extracts resource utilization features from the telemetry data. This forms preprocessed telemetry data with key features 412, which is then input (in step 1) to an AI-driven telemetry analysis component 414. The telemetry analysis function 414 detects trends in usage and flags deviations from normal patterns through anomaly detection 413, and then predicts future resource bottlenecks 417. These predicted resource hotspots 416 are transmitted (in step 2) to a generative AI summary layer 418.

The generative AI summary layer 418 transforms telemetry insights into concise, actionable summaries using models like GPT. This layer simplifies data interpretation, enabling customers to quickly grasp complex issues and act accordingly. For example, specific issues, such as “100K backup copies pending deletion,” can generate recommended actions for resolution. The actionable recommendations provided by the summary layer 418 are provided to a proactive notification interface 420 (step 3).

The proactive notification interface 420 ensures timely communication by sending email-based monthly reports 427 that summarize detected issues and provide actionable options, such as authorizing support ticket creation. System 400 streamlines customer interactions by integrating proactive notifications into their workflows. A response validation unit 426 confirms authorized actions, which are then transmitted (in step 4) as customer approved actions 422 to an automated support ticket generator 424.

The automated support ticket generator 424 closes the loop by creating service requests with all necessary logs in real-time upon customer approval, ensuring swift and efficient resolution of identified problems.

In general, the solution provided by system 400 requires continuous telemetry data collection from backup systems, an integration framework with APIs for seamless communication and ticketing, and the deployment of AI algorithms such as LSTM for trend forecasting and transformer models like GPT for generating actionable insights, and further technical detail about each of the main functional components of system 400 are provided below.

In an embodiment, the telemetry analysis module 414 leverages Long Short-Term Memory (LSTM) networks to process sequential telemetry data and forecast resource hotspots. The LSTM network 415 analyzes the time-series data by retaining long-term dependencies using memory cells, input gates, output gates, and forget gates. These gates allow the model to filter out irrelevant data while focusing on meaningful trends. The module processes features such as CPU utilization, memory usage, disk I/O rates, network throughput, policy schedules, and event logs.

LSTMs are particularly effective in learning from sequential data, capturing temporal dependencies in file access behavior. By predicting future access trends, the system can proactively re-index files based on anticipated changes, adjusting priorities accordingly. The LSTM model is trained on historical access logs and metadata or data, enabling it to identify recurring patterns such as daily, weekly, or seasonal spikes in usage. This predictive approach allows the system to adapt the prediction process.

The LSTM-based pattern analysis component 415 performs real-time QoS-based trend analysis to identify resource utilization trends at system, subsystem, and component-module levels. It also analyzes inter-process flows and suggests dynamic resource reallocation to mitigate bottlenecks upstream/downstream resource mapping. A health rating system is used to track system components approaching threshold limits (e.g., components running at >70% utilization in the last week) and correlates them with workload patterns (e.g., impact of different policies on resource spikes). For example, if telemetry data shows consistent growth in storage utilization, LSTM can predict when the storage capacity is likely to run out.

The LSTM analysis component 415 uses certain features to understand patterns across multiple dimensions of resource utilization. Features like memory usage during backup windows and disk I/O spikes caused by overlapping jobs are correlated to predict high memory pressure. The analysis module 415 also considers historical seasonality patterns, such as month-end peaks in activity due to policy schedules, and so on. Input features are normalized to ensure uniform scaling, and additional engineered features, such as the rolling mean or exponential moving averages of resource usage, are used to enhance the model's accuracy. This feature-rich input enables the module to make reliable predictions for complex environments.

In an embodiment, the forecasting function 417 is calculated by the following formula:

yₜ₊₁=f(Wxₜ+b)

In the above equation, xₜ represents a feature vector at time t (e.g., CPU, memory, and I/O data), W is the matrix of model weights, and b is the bias term.

An example prediction might be expressed as follows: if telemetry data shows storage utilization increasing by 5% weekly, LSTM forecasts depletion within three weeks, which would then trigger proactive recommendations.

To ensure data integrity, the framework incorporates an anomaly detection mechanism 512 that identifies potential issues like data corruption or unauthorized changes, to increase the reliability of recovery points 610. These issues are detected by analyzing metadata across certain characteristics, such as change rates, unusual access patterns, or irregular modification patterns, among others. For example, a sudden spike in the change rate of critical files or access from unverified sources could indicate potential corruption or unauthorized activity, triggering an alert for corrective actions.

To ensure the integrity and accuracy of the prediction process, the anomaly detection mechanism 512 continuously monitors file access logs and resource usage. This component identifies irregularities such as unauthorized access, system failures, and the like. An embodiment uses autoencoders, advanced deep learning models, for anomaly detection. Autoencoders analyze file behavior by reconstructing normal access patterns and detecting deviations when reconstruction errors occur. When anomalies are detected, alerts are triggered, and the system takes corrective actions to maintain hotspot prediction accuracy. Real-time monitoring ensures that anomalies are detected and addressed promptly, enhancing the reliability of recovery points.

To ensure data integrity, the analysis component 414 incorporates an anomaly detection mechanism 413 that identifies potential issues like data corruption or unauthorized changes, to increase the reliability of the trend detection and pattern analysis 415. These issues are detected by analyzing metadata across certain characteristics, such as change rates, unusual access patterns, or irregular modification patterns, among others. For example, a sudden spike in the change rate of files or access from unverified sources could indicate potential corruption or unauthorized activity that represents a deviation that should not be processed as part of the prediction.

To ensure the integrity and accuracy of the detection process, the anomaly detection mechanism 413 continuously monitors system behavior to identify certain defined irregularities. An embodiment uses autoencoders, advanced deep learning models, for anomaly detection. Autoencoders analyze file behavior by reconstructing normal access patterns and detecting deviations when reconstruction errors occur. When anomalies are detected, alerts are triggered, and the system takes corrective actions to maintain proper prediction operation.

As further shown in FIG. 4, system 400 includes a generative AI summary layer 418 that receives predictions of resource hotspots 416 from the analysis unit 414. This layer 418 transforms telemetry insights into concise, actionable reports 421 using transformer-based models like Generative Pre-trained Transformer (GPT) 419, which is a neural network designed for NLP tasks like text generation and translation. An issue contextualization unit 423 maps hotspots to operational impacts.

Overall, the generative AI summary layer 418 features QoS-driven summarization 419 to highlight issues linked to performance degradation, service level agreement (SLA) breaches, and policy misalignments. It also provides root cause analysis and actionable recommendations 421 by correlating high resource utilization with specific workload patterns to suggests possible optimizations. It further features a dynamic template system that generates adaptive reports tailored to customer environments through the issue contextualization 423.

Key input features to this layer include telemetry sequences (e.g., storage usage trends, deletion queue sizes, and backup success rates) and metadata, such as timestamps and impacted resource IDs. The model employs tokenized embeddings of this data to capture contextual relationships, enabling it to generate human-readable reports tailored to specific scenarios. For instance, if telemetry data reveals “100K backup copies pending deletion” with increasing queue sizes over several hours, the output summary might state: “Our telemetry shows a backlog of 100K backup copies pending deletion, which could impact storage efficiency. Recommended action: optimize deletion schedules or allocate additional temporary storage to handle the backlog.”

The system incorporates attention mechanisms to prioritize critical features like high-priority tasks, resource contention, and policy violations, ensuring the generated summaries emphasize actionable insights. It also applies context-switching capabilities to align summaries with customer environments. For example, a summary may state “Our telemetry shows that every time Policy 1 and Policy 3 execute together, memory utilization exceeds 70%, leading to backup slowdowns,” and a recommended action may be to stagger policy execution or allocate additional memory.

The summaries are further refined using reinforcement learning with human feedback (RLHF). Here, human evaluators rank the quality of generated reports based on clarity, relevance, and actionable detail. The reward model guides the fine-tuning process, ensuring customer-focused outputs.

Output from the generative AI summary layer 418 is provided to a proactive notification interface 420 that is designed to deliver telemetry-driven insights and recommended actions directly to customers via automated email reports or other message formats (e.g., SMS/text message, web alerts, etc.). This interface uses a rule-based trigger mechanism that analyzes telemetry predictions from the LSTM-based analysis module 414 and sends notifications either periodically (e.g., monthly) or upon detecting anomalies. These messages, as generated by a report distribution unit 427, contain a structured report summarizing issues like replication backlogs, resource exhaustion, or policy conflicts.

In an embodiment, the proactive notification interface 420 features an interactive resource map that enables users to adjust resource allocations directly within the interface. It generates QoS-based action recommendations to suggests adjustments based on system health and policy execution history. It is also integrated with ITSM platforms to allow users to authorize ticket creation with a single click. For example, a notification by be expressed as “”25K backup copies pending replication due to target system unavailability. Estimated resolution time: 48 hours. Would you like to reallocate resources or create a support ticket?”

The proactive notification interface 420 also integrates with customer communication platforms via RESTful APIs, enabling real-time interactions while preserving metadata fidelity. Reports include dynamic features such as resource IDs, timestamps, issue impact, and confidence scores derived from telemetry predictions. To ensure actionable outputs, the interface provides interactive options like clickable checkboxes or buttons for authorizing specific actions (e.g., creating a support ticket or reallocating resources). A response validation unit 426 confirms authorized actions, which are then transmitted as customer approved actions 422 to an automated support ticket generator 424.

The automated support ticket generator 424 comes next to the notification interface 420 by streamlining the resolution process through end-to-end automation. Once a customer approves action via the email interface, the system uses secure API integrations with ticketing platforms such as ServiceNow or Zendesk (or similar) to generate Service Requests (SRs). These service requests include comprehensive issue descriptions, relevant telemetry data, and system logs. An example ITSM ticket might be: “Storage forecast indicates depletion within three weeks at 5% weekly growth. Logs and telemetry trends attached for detailed analysis.”

In an embodiment, the support ticket generator 424 also utilizes Natural Language Generation (NLG) to craft the service request descriptions, ensuring they are clear, concise, and aligned with ITSM workflows. By automating ticket creation and including metadata such as historical trends, thresholds, and anomaly details, the system 400 reduces delays associated with manual intervention. This proactive mechanism ensures faster response times, optimized workflows, and enhanced system reliability, enabling customers to address critical issues before they escalate.

The NLG functions may utilize a natural language processing (NLP) interface that is a user-facing system allowing natural language interactions with users for more intuitive and precise information exchange. The NLP interface enables users to interact naturally with the system, such as by allowing natural language text input and output for ease of use and understanding.

In an embodiment, the recommendation engine 421 can be extended beyond support to sales by automatically raising infrastructure or licensing requests based on detected resource needs. This can include license optimization suggestions that identify when additional licensing is needed based on actual workload demands, hardware/infrastructure recommendations that suggest optimal compute/storage resources based on historical trends and projected needs, and automated sales requests that directly submit proposals to a vendor's sales engine for customer review. An example recommendation may be expressed as: “Our analysis shows that additional storage of 10TB will be required within six months based on current trends. Would you like to request an upgrade?”

System 400 can be implemented in any type of customer/user environment, such as a closed or open (cloud-based) large-scale network. Likewise, the proactive notification interface 420 can generate an appropriate interactive resource map depending on system resources, network topography, user requirements, and so on, to enable users to adjust resource allocations directly within the interface, as needed.

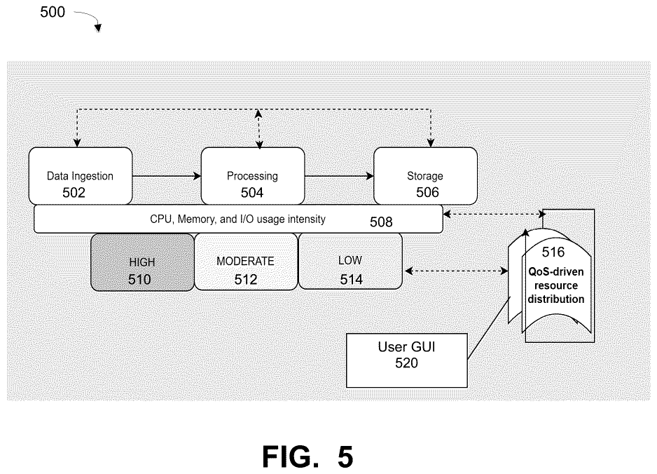

FIG. 5 illustrates a proactive notification interface output for an example system, under some embodiments. Diagram 500 of FIG. 5 shows an example cloud backup workflow hotspot map that visualizes data flow across ingestion 502, processing 504, and storage 506 to highlight upstream/downstream dependencies among different resources, such as CPU, memory, and I/O usage. Indicator blocks can indicates resource utilization with graphically-coded intensity based along a scale, such as high 510, moderate 512, and low 514. Any appropriate graphical cue can be used, such as color (e.g., red for high, yellow for moderate, green for low), gray-scale, shading, borders, and so on.

In an embodiment, the interface provides GUI-based user input mechanisms 520 to allow users to interactively scale resources by clicking on nodes (e.g., increasing storage capacity), with real-time updates ensuring optimized QoS-driven resource allocation.

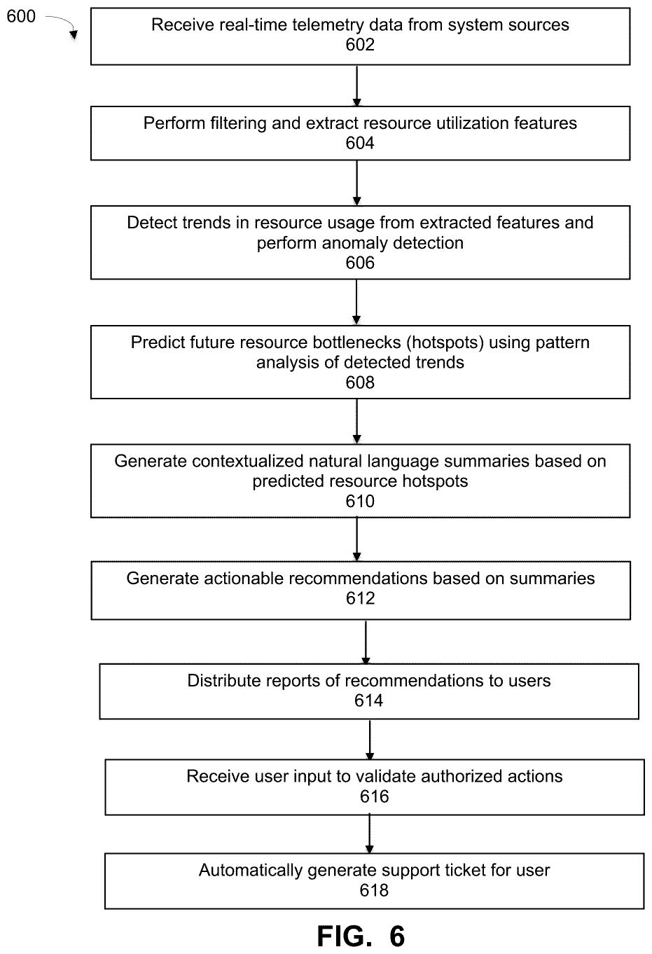

FIG. 6 is a flowchart that illustrates an overall method of providing resource hotspot detection and automated support, under some embodiments. As shown in FIG. 6, process 600 begins with receiving real-time telemetry data from various resources and resource using applications in the system, 602. The resources can comprise CPU, memory, interface, and similar resources, and the telemetry data can comprise memory usage, CPU bandwidth usage, disk I/O spikes, network traffic, and so on. The telemetry data can be generated and received (collected) as time-series streaming data formatted in any appropriate form.

The telemetry data is then processed through filtering and feature engineering to extract resource utilization features, 604. These features can include CPU utilization, memory usage, disk I/O rates, network throughput, policy schedules, event logs, and other similar characteristics related to relevant system resources, configuration, and application use.

The extracted resource utilization features are then provided to an AI-driven analysis unit to detect trends in resource usage, 606. During this process, anomalies based on defined standards in the telemetry data are detected to flag and accommodate any deviations from normal patterns to maximize the accuracy of the predictions. The future resource hotspots are predicted using pattern analysis (such as by LSTM models) of the detected trends, 608.

The predicted hotspot information is then used to generate natural language summaries, 610, and issue contextualization can be used to map hotspots to operational impacts. Actionable recommendations are then generated based on the summaries, 612. The recommendations can be expressed in plain language for the user and provided through a suitable notification interface, such as by e-mail or other message reports distributed to the user or users, 614. User feedback may be provided to validate any automated actions that are recommended or initiated, 616.

Depending on the network and vendor/customer environment, an appropriate support ticket may be generated to initiate a response through a valid agent or third party, 618. For an environment that comprises a large-scale network executing a complicated and well-supported product or platform, such as a deduplication backup system in Santorini, provided by a vendor (e.g., Dell Technologies), a support ticket may comprise escalation to a customer service center that will coordinate the involvement of appropriate technical service personnel to address the bottleneck issue.

Embodiments of process 600 thus provide AI-driven QoS-based resource optimization, which maps telemetry insights to actionable QoS-driven decisions. They also enable interactive resource mapping for dynamic adjustments, and incorporate a health rating system with correlation analysis to provide deep insights into system behavior, root cause analysis, and proactive remediation.

This solution provides proactive detection that identifies resource hotspots before they lead to system failures, as well as actionable insights that provide clear, context-rich summaries with recommended actions. Through automation it streamlines ticket creation and resolution workflows, reduces response times, and minimizes manual analysis. It further enhances customer communication with real-time updates, and provides improved QoS adherence to ensure better service availability and system reliability.

In an embodiment, the intelligent hotspot detection process 112 utilizes certain artificial intelligence (AI) and machine learning (ML) processes to evaluate metadata to generate a model and predict hotspots accordingly. Such a process generally uses a training component that continuously trains a machine learning algorithm.

Embodiments of the processes and techniques described above can be implemented on any appropriate backup system operating environment or file system, or network server system. Such embodiments may include other or alternative data structures or definitions as needed or appropriate. The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

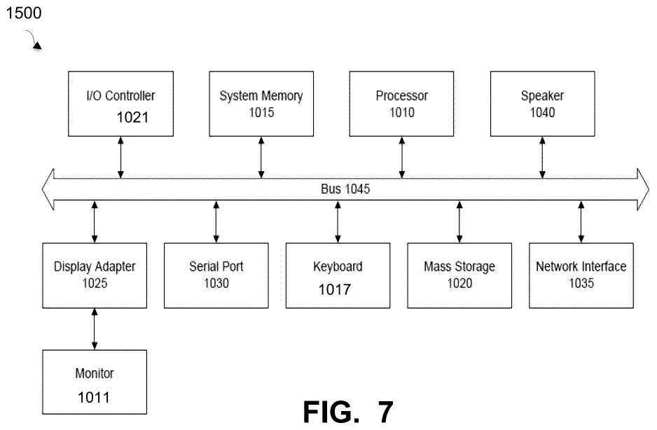

The network of FIG. 1 may comprise any number of individual client-server networks coupled over the Internet or similar large-scale network or portion thereof. Each node in the network(s) comprises a computing device capable of executing software code to perform the processing steps described herein. FIG. 7 is a block diagram of a computer system used to execute one or more software components of the processes described herein, under some embodiments. The computer system 1500 includes a monitor 1011, keyboard 1017, and mass storage devices 1020. The computer system further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. The processor 1010 may include multiple processors or a multicore processor, which may permit parallel processing of information. Computer system 1500 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac™ OS X, IRIX32, or IRIX64. Other operating systems may be used.

Embodiments can include computer-readable storage medium containing computer-readable instructions or computer program code. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Although certain embodiments have been described and illustrated with respect to certain example network topographies and node names and configurations, it should be understood that embodiments are not so limited, and any practical network topography is possible, and node names and configurations may be used.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). A network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but other sequences may be possible and some may be performed in parallel. Additionally, steps may be subdivided or combined. As disclosed herein, software written in accordance with the present invention may be stored in some form of computer-readable medium, such as memory or CD-ROM, or transmitted over a network, and executed by a processor.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of identifying bottlenecks for application execution in a distributed network, comprising:
receiving real-time telemetry data from resources and applications of the distributed network;
extracting resource utilization features from the telemetry data;
detecting trends in resource usage from the resource utilization features;
performing pattern analysis of the detected trends to predict future resource bottlenecks as predictions;
generating a natural language summary and actionable recommendation for bottleneck minimization based on the predictions; and
providing the summary and recommendation to one or more users for validation and guidance.

2. The method of claim 1 further comprising automatically generating a support ticket for use by the user or a third party to minimize the bottleneck based on the summary and recommendation.

3. The method of claim 2 wherein the resources comprise processor, memory, disk, and interface components, and further wherein the telemetry data comprises memory usage, CPU bandwidth usage, disk I/O spikes, and network traffic, and further wherein the resource utilization features comprise at least one of: processor utilization, memory usage, disk input/output (I/O) rates, network throughput, policy schedules, and event logs.

4. The method of claim 3 wherein the pattern analysis is performed using a long-short term memory (LSTM) model to predict future resource usage trends from the real-time telemetry data, and further wherein the LSTM model is trained on historical data to identify recurring patterns with respect to usage spikes.

5. The method of claim 4 wherein the pattern analysis further comprises:
performing quality of service (QoS) trend analysis identifying resource utilization trends at system, subsystem, and component levels;
performing upstream/downstream resource mapping analyzing inter-process flows to discover possible resource allocations to reduce the bottleneck;
tracking system components to identify component running within a defined percentage of operating limits; and
factoring historical seasonality patterns to enhance the LSTM model.

6. The method of claim 4 further comprising performing anomaly detection as part of the detecting step to accommodate for any deviations in resource usage from normal patterns as defined by set thresholds to improve accuracy of the predictions.

7. The method of claim 2 wherein the natural language summary is generated by a generative artificial intelligence (AI) component that further provides issue contextualization by mapping predicted hotspots to operational impacts for the distributed network, and that correlates high resource utilization with specific workload patterns, highlights issues related to performance degradation and service level agreement (SLA) breaches and policy misalignments.

8. The method of claim 2 wherein the providing step is performed by a proactive notification interface that includes a user feedback interface to receive user validation to confirm authorized actions to minimize the predicted future resource bottlenecks.

9. The method of claim 8 wherein proactive notification interface comprises a graphical user interface (GUI) based interactive resource map that displays resource usage along a qualitative scale and allows the user to adjust resource allocations directly within the GUI to view changes in resource usage.

10. The method of claim 2 wherein the support ticket comprises a service request transmitted to support personnel of the user or a vendor of an application executed in the distributed network.

11. The method of claim 1 wherein the distributed network comprises a Santorini network processing containerized data utilizing a Kubernetes-based framework, and that comprises part of a Data Domain deduplication backup system performing backup operations for the nodes, and further wherein the bottleneck is caused by an excessive delay in deleted of expired backup filed queued for deletion.

12. A system for identifying bottlenecks for application execution in a distributed network, comprising:
a telemetry data collector receiving and extracting resource utilization features real-time telemetry data from resources and applications of the distributed network;
a telemetry analysis component detecting trends in resource usage from the resource utilization features, and performing pattern analysis of the detected trends to predict future resource bottlenecks as predictions;
a generative summary component generating a natural language summary and actionable recommendation for bottleneck minimization based on the predictions; and
a notification interface providing the summary and recommendation to one or more users for validation and guidance.

13. The system of claim 12 further comprising a support ticket generator automatically generating a support ticket for use by the user or a third party to minimize the bottleneck based on the summary and recommendation.

14. The system of claim 13 wherein the resources comprise processor, memory, disk, and interface components, and further wherein the telemetry data comprises memory usage, CPU bandwidth usage, disk I/O spikes, and network traffic, and further wherein the resource utilization features comprise at least one of: processor utilization, memory usage, disk input/output (I/O) rates, network throughput, policy schedules, and event logs.

15. The system of claim 13 wherein the pattern analysis is performed using a long-short term memory (LSTM) model to predict future resource usage trends from the real-time telemetry data, and further wherein the LSTM model is trained on historical data to identify recurring patterns with respect to usage spikes, and further telemetry analysis component further:
performs quality of service (QoS) trend analysis identifying resource utilization trends at system, subsystem, and component levels;
performs upstream/downstream resource mapping analyzing inter-process flows to discover possible resource allocations to reduce the bottleneck;
tracks system components to identify component running within a defined percentage of operating limits; and
factors historical seasonality patterns to enhance the LSTM model.

16. The system of claim 15 further comprising an anomaly detector performing anomaly detection as part of the detecting step to accommodate for any deviations in resource usage from normal patterns as defined by set thresholds to improve accuracy of the predictions.

17. The system of claim 13 further comprising a generative artificial intelligence (AI) component that further provides issue contextualization by mapping predicted hotspots to operational impacts for the distributed network, and that correlates high resource utilization with specific workload patterns, highlights issues related to performance degradation and service level agreement (SLA) breaches and policy misalignments.

18. The system of claim 13 wherein the notification interface includes a user feedback interface to receive user validation to confirm authorized actions to minimize the predicted future resource bottlenecks, and further comprises a graphical user interface (GUI) based interactive resource map that displays resource usage along a qualitative scale and allows the user to adjust resource allocations directly within the GUI to view changes in resource usage.

19. The system of claim 12 wherein the distributed network comprises a Santorini network processing containerized data utilizing a Kubernetes-based framework, and that comprises part of a Data Domain deduplication backup system performing backup operations for the nodes, and further wherein the bottleneck is caused by an excessive delay in deleted of expired backup filed queued for deletion.

20. A method of identifying bottlenecks for application execution in a distributed network, comprising:
receiving real-time telemetry data from resources and applications of the distributed network, and extracting resource utilization features from the telemetry data;
detecting trends in resource usage from the resource utilization features, and performing pattern analysis of the detected trends to identify a bottleneck for reporting to a user;
performing quality of service (QoS) trend analysis identifying resource utilization trends at system, subsystem, and component levels;
performing upstream/downstream resource mapping analyzing inter-process flows to discover possible resource allocations to reduce an identified bottleneck;
tracking system components to identify component running within a defined percentage of operating limits; and
factoring historical seasonality patterns to enhance the pattern analysis.
